(19) United States
(12) Patent Application Publication
(10) Pub. No.: US 2014/0313998 A1
(43) Pub. Date: Oct. 23, 2014

(54) METHOD AND APPARATUS FOR ESTABLISHING INTERNETWORK COMMUNICATION BETWEEN TELECOMMUNICATION DEVICES

(71) Applicant: KANFIELD CAPITAL SA, Panama (PA)

(72) Inventor: Bodgan Ionut Sorescu, Craiova (RO)

(73) Assignee: KANFIELD CAPITAL SA, Panama (PA)

(21) Appl. No.: 14/254,432

(22) Filed: Apr. 16, 2014

Related U.S. Application Data
(60) Provisional application No. 61/812,921, filed on Apr. 17, 2013.

(51) Int. Cl. H04W 76/02; H04M 7/00

(52) U.S. Cl. CPC H04W 76/021; H04M 7/0003
USPC 370/329

(57) ABSTRACT

Systems and methods for connecting long distance and international calls between two telecommunications devices, without incurring tariff charges, are disclosed.

### CROSS REFERENCE TO RELATED APPLICATIONS

This application relates to, and claims the benefit of the earlier filing date and priority of U.S. Provisional Patent Application No. 61/812,921, filed on Apr. 17, 2013, entitled “Method And Apparatus For Establishing A Long Distance Telephone Call.”

### FIELD OF THE INVENTION

The present invention relates generally to methods and apparatuses for facilitating communication between two or more devices accessible from different communication networks.

### BACKGROUND OF THE INVENTION

Telecommunication devices, such as mobile phones, landline phones, and satellite phones, are commonly used to facilitate communication between one or more persons. Communication using these telecommunication devices may be in the form of voice communication, text messages, instant messaging, sound (e.g., audible alerts), video, picture, or multi-media information. Voice communication may be with one person or with more than one person in the form of a three-way call or a conference call.

For voice communication, the caller may dial a number from his telecommunication device and the call may be routed through one or more telecommunication networks to the recipient's telecommunication device. Alternatively, the call may be routed through the Internet, or a combination of the Internet and the telecommunication networks. Once aware of the incoming call, the recipient may choose to receive the call and communicate with the caller, or may choose to not answer the call. Likewise, the caller may send a message in the form of a text message, picture, audio file or indicator, video recording, or other multimedia content to one or more recipients. These messages may be routed through the telecommunication network and/or the Internet to the recipient's telecommunication device. The recipient's telecommunication device may alert the recipient of the incoming message, and the recipient may view and respond to the incoming message or may choose to view it at a later time

It is well known that a caller may initiate a conventional voice telephone call between two parties situated in different countries, i.e. international telephone call, through a telecommunication device. A telecommunication services provider, such as mobile phone service provider or the Public Switch Telephone Network (“PSTN”), may then complete the connection to a callee at a callee's location. To complete the call from the caller to the callee, the call may be routed through the networks of long distance and/or international carriers. It is well known that the long distance and international carriers may each impose tariffs for completing the call based on a variety of criteria. Once the call is completed, the caller's phone service provider may bill the caller for servicing the call.

For prepaid calling services, the caller's account may be debited for the call. It is also known that a variety of techniques and configurations may be utilized for selecting the various intermediate telecommunications providers to complete a long distance call and to ensure that the call is completed at the most favorable rates.

One disadvantage in completing a call between the caller and a callee in different countries is that the telephone call may be routed through multiple telecommunications providers who are located in foreign countries relative to the caller's location. In these situations, the caller may incur charges for use of the telecommunications network in one or more foreign countries, which may include onerous tariff charges. If the caller is using a mobile phone to make the international call then the caller may have to pay additional charges to his mobile operator. Unlike landline service, for which rates for outbound calling has dropped sharply due to competition between alternate long distance carriers and Voice over IP (VoIP) services, the costs of long distance and international calling and roaming have remained comparatively more expensive for most mobile networks.

One way to alleviate the problem of high costs for international calls is to use the Internet for voice calls. For example, audio interface software may enable phone-like connections over the Internet. Some examples of these types of services are MSN Messenger, Yahoo Messenger, AIM/ICQ, and Skype. This software operates by compressing audio and sending it over a TCP/IP connection as digital information. The major advantage of this type of technology is that it permits users to make telephone calls that bypass telephone companies and their charges. However, a disadvantage of this type of calling is that both caller and callee have to be logged on to the Internet simultaneously. Moreover, services such as MSN Messenger, Yahoo Messenger, AIM/ICQ, and Skype do not support voice services except on high-end smartphones or portable PCs.

Thus, there is a need for a method and apparatus for providing long distance communication at reduced costs, especially for users using mobile communication devices.

### SUMMARY OF THE INVENTION

The present teaching is generally directed to methods and apparatuses for establishing a call between communication devices. Embodiments of the present invention include methods and apparatuses for seamlessly carrying out long distance communication using a telecommunication device, such as a mobile phone. Various embodiments of the present invention provide a method and apparatus for carrying out a telephone call over long distances without incurring charges for the use of one or more telecommunications networks in foreign countries.

Responsive to the foregoing challenges, Applicant has developed an innovative telecommunication method comprising: retrieving, using a telecommunications system, an electronically stored first identifier associated with a first device; retrieving, using the telecommunications system, an electronically stored second identifier associated with a second device; temporarily assigning, using the telecommunications system, first local access information to the first device; associating, using the telecommunications system, the first local access information with the first identifier; temporarily assigning, using the telecommunications system, second local access information to the second device; associating, using the telecommunications system, the second local access information with the second identifier; and establishing a bridged communication, under the control of the telecommunications system, between the first device and the second device using the first local access information and the second local access information.

Applicant has further developed an innovative telecommunication method comprising: retrieving, using a telecommunications system, an electronically stored first identifier associated with a first device; retrieving, using the telecommunications system, an electronically stored second identifier associated with a second device; temporarily assigning, using the telecommunications system, second local access information to the second device; associating, using the telecommunications system, the second local access information with the second identifier; and placing a call, under the control of the telecommunications system, from the first device to the second device using the second local access information.

Applicant has still further developed an innovative telecommunication method comprising: activating, using a telecommunications system, a first communication device on a local server; authenticating the first communication device, using a telecommunications system; retrieving an electronically stored first identifier associated with the communication device, using a telecommunications system; establishing, using a telecommunications system, an account for the first communication device; adding one or more selected contacts accessible from the first communication device to a database associated with the account for the first communication device, using a telecommunications system; retrieving, using the telecommunications system, an electronically stored second identifier associated with a second communication device associated with one of the selected contacts; temporarily assigning, using the telecommunications system, local access information to the second communication device; associating, using the telecommunications system, the second local access information with the second identifier; providing the local access information assigned to the second communication device to the first communication device.

Applicant has still further developed an innovative communications system comprising: a first communication device capable of accessing a local client application; a database suited to electronically maintain information about one or more communication devices, the information comprising an identifier associated with a communication device and local access information for the communication device; an XMPP server adapted to communicate with the local client application; a SIP Environment connected to the XMPP server and adapted to communicate with at least one of the one or more communication devices; and a user database accessible to the XMPP server and the SIP Environment

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements. The drawings are exemplary only, and should not be construed as limiting the invention.

FIG. 1 is a flow chart illustrating a process for registering a user or caller with a Local Server and for activating the Local service for the registered user in accordance with an embodiment of the present teaching.

FIG. 2 is an exemplary block diagram of a process for placing international telephone calls using the Local Server service for international calling in accordance with an embodiment of the present teaching.

FIG. 3 is an exemplary block diagram for receiving international telephone calls using the Local Server service for international calling in accordance with an embodiment of the present teaching.

FIG. 4 is an exemplary schematic diagram illustrating the architecture and operation of the Local Server service for international calling in accordance with an embodiment of the present teaching.

FIG. 5 is an exemplary schematic diagram illustrating the architecture and operation of an alternative Local Server service for international calling in accordance with an embodiment of the present teaching.

FIGS. 6A and 6B are an exemplary call flow diagram illustrating the process for registering the user with a Local Server and for activating the Local Server service for the registered user in accordance with an embodiment of the present teaching.

FIG. 7 is an exemplary call flow diagram illustrating the process for originating international telephone calls using the Local Server service in accordance with an embodiment of the present teaching.

FIG. 8 is an exemplary call flow diagram illustrating the process of a called party answering a call from a user instead of rejecting the call and calling back in accordance with an embodiment of the present teaching.

FIGS. 9A and 9B are an exemplary call flow diagram illustrating the connection of international telephone calls using the Local Server service in accordance with an embodiment of the present teaching.

FIG. 10 is an exemplary diagram of a dedicated route between a user and the user's contact in accordance with an embodiment of the present teaching.

FIG. 11 is an exemplary flow chart diagram of a process for terminating a call using a Local Server service in accordance with an embodiment of the present teaching.

### DETAILED DESCRIPTION OF EMBODIMENTS OF THE INVENTION

An embodiment of the invention utilizes a network and network devices to facilitate communication between telecommunication devices in a manner that circumvents the use of intermediary carriers typically required to complete a long distance or international call. Embodiments of the present invention include both apparatuses and methods for permitting and enabling telecommunication devices to communicate over long distances and may reduce the cost previously associated with such communications by circumventing long distance and international telecommunications carriers.

The various apparatus and methods discussed herein may be implemented between telecommunication devices that are connected through a telecommunication network, over the Internet, or via a combination thereof. One skilled in the art will recognize that the present invention can be implemented using any type of telecommunication device, including, for example, conventional telephones, wireless telephones, cellular telephones, personal digital assistants (PDAs), personal communication devices, smart phones, tablet computers, handheld email devices, handheld computers, desktop computers, laptop computers, or any communication device capable of transmitting and receiving information via a video or telecommunication related service. An exemplary embodiment of the telecommunication device may be capable of voice services and/or data services over networks such as GSM/GPRS/EDGE, UMTS, CDMA, WiFi, WiMAX, 3G, 4G, LTE, EVDO, mesh, or other networks types. Accordingly, any particular structure and design of the telecommunication devices is merely one example of a physical device for implementing the techniques of the present invention, and is presented for illustrative purposes and not to imply any limitations on the scope of the present invention. To the extent that the present invention is composed of electronic components and circuits, which are generally known to those skilled in the art, circuit details are not specified in order not to detract from the teachings of the present invention.

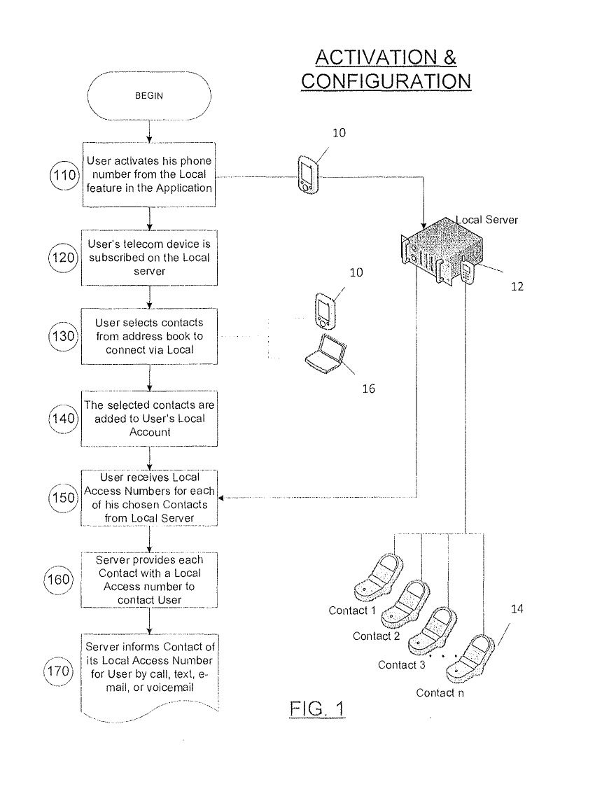

Reference will now be made in detail to one or more embodiments of the present invention, examples of which are depicted in the accompanying FIGS. 1-10. In one embodiment of the present teaching, a client Application—which may include but is not limited to a computer program, software, script, executable file, client, or application—runs on a communication device 10. In an embodiment of the present teaching, the client Application is a mobile application client that may be provided as a download and installed on the user's telecommunication device 10. The client Application may be adapted to run on a range of application platforms, including, for example, J2ME, Windows Mobile, Windows 8, Windows RT, Blackberry OS, iOS, Android, Symbian, Palm OS, or the like. The client Application may also be adapted to run on Windows, Chrome, Unix, Linux, Mac OS, and other similar operating systems supported on handheld/desktop computers and the like. In one embodiment, the client Application may be pre-installed on a communication device or available for download from a variety of repositories, including, for example, Google Play, Apples' iTunes or App Store, Windows' Store, Amazon's Appstore, or the like. The client Application may further be available for download at a FTP or Internet site or from a local or network drive.

In one embodiment, the client Application may be a portal that provides access to a suite of applications, including, for example, a Local client. A user may access the Local client from the client Application portal after downloading and installing the client Application on the user's telecommunication device 10, as described above. In another embodiment, the Local client may be a standalone application that the user may download and install on the telecommunication device 10.

The telecommunication device 10 may include one or more mechanisms for accepting input from the user. In one embodiment, the screen is touch-sensitive, so that the user may interact with the telecommunication device 10 by touching or writing on the surface of screen using a stylus, finger, or other object. In another embodiment, in addition to, or as a surrogate for, the touch-sensitive screen, the telecommunication device 10 may include a QWERTY keyboard, or any other type of keyboard or button or swipe based interface, for enabling rapid entry of an input, including text, and may further include buttons for performing various other functions associated with the operation of the telecommunication device and its applications. The telecommunication device 10 may also have a memory that stores, and a processor that executes, the client Application and/or the Local client.

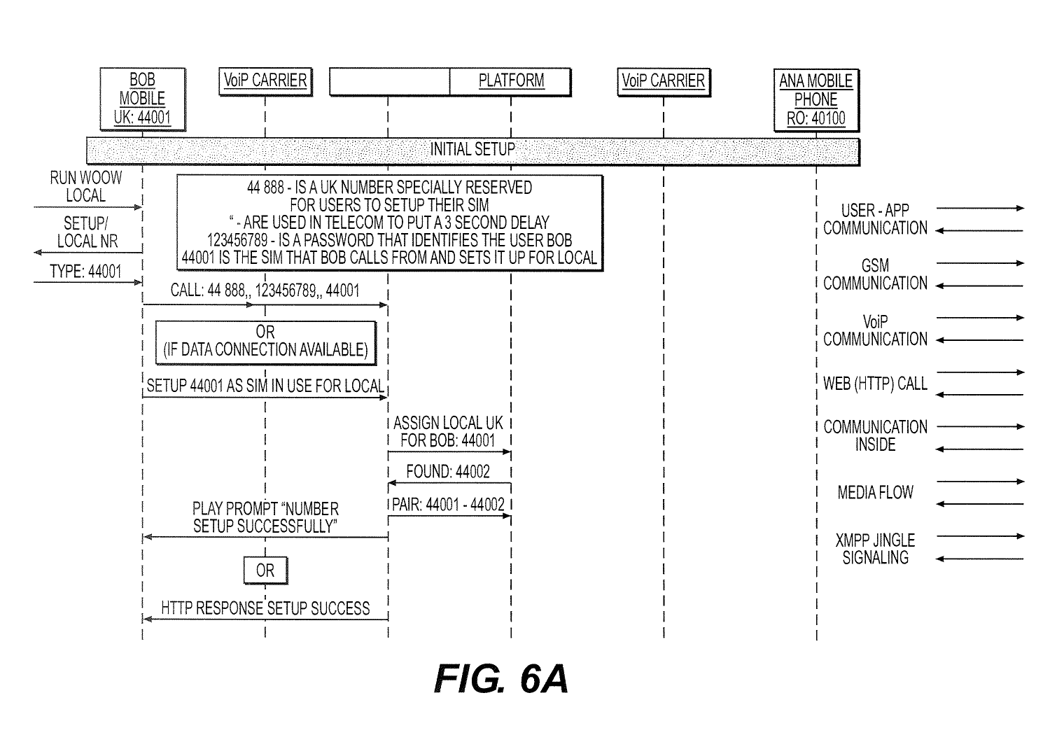

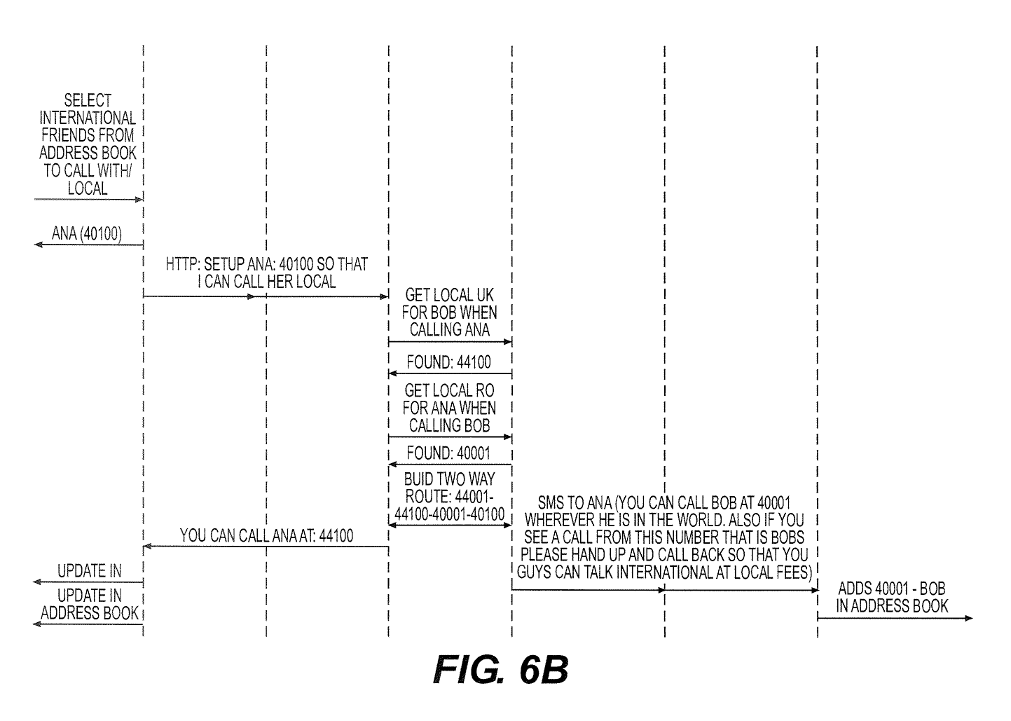

FIGS. 1 and 6A-6B illustrate a process of activating and configuring the user telecommunication device 10 on the Local system according to one embodiment of the present teaching. In one embodiment depicted in FIG. 1, a user activates a phone number associated with his communication device 10 from a Local feature in the client Application 110. The communication device 10 in this embodiment is connected or has access to a Local Server 12 and is subscribed on the Local Server at step 120. The user selects contacts to connect using the Local client in step 130. In one embodiment, these contacts are selected from a list of contacts, such as those organized in an address book or other database maintained on the communication device or remote storage system 16 that is accessible to the communication device. In one embodiment, each contact is associated with an electronically stored identifier. In another embodiment, devices whose access information is stored or otherwise maintained in the list of contacts is associated with an electronically stored identifier. The selected contacts are added to the user's Local Account in step 140 and the user receives Local Access Numbers or another form of local access information corresponding to a one or more communication devices associated with one or more of the selected contacts from the Local Server 12 in step 150. The Local Server 12 provides the one or more communication devices associated with one or more of the selected contacts with a Local Access Number or other local access information associated with the user communication device 10 and informs each contact of the Local Access Number 160.

As shown in FIG. 6A, if the user device 10 has a data connection, the user device may initiate the activation and configuration process for the Local service by running the Local client. As shown in FIG. 6A, the user device 10 may be manipulated to dial a number specifically assigned for Local client setup. The user device 10 may be used to provide a pass code, which identifies the user device and permit the activation and configuration process to proceed for Local client setup. In an alternate embodiment, the user device 10 may be used to call a dedicated registration number to register, activate and configure the Local client on the user device. Registration and activation through the dedicate registration number may be automated or may be conducted by a call center representative.

As shown in FIGS. 1 and 6A, in step 110, the user device 10 (e.g., Bob's device) may be used to activate the Local client in the Application Portal. When the user device 10 has been activated on the Local Server, in step 120, the Local Server 12 may authenticate the user device 10 and may associate a unique user ID (“UID”), preferably the user device 10 phone number or the user device's Subscriber Identity Module (“SIM”) card number to identify the user device on the Local Server. Other types of user IDs, including, for example, Electronic Serial Number (“ESN”) number, International Mobile Station Equipment Identity (“IMEI”) number, or International Mobile Subscriber Identity (“IMSI”) number, proxy ID, personal user ID, mobile device user ID, application user ID, MAC address, an ID derived from ‘fingerprint’ or other biometric information, and the like may also be used to identify the user device 10 on the Local Server 12. The Local Server 12 then sets up a account for the user device 10, which is associated with the UID. As shown in FIG. 6A, the user device 10 may be informed that the setup process has been successfully completed by a prompt.

In step 130, the user device 10 may be used to select contacts from the user device address book with whom the user desires to communicate through the Local service. As shown in FIGS. 1 and 6A-6B, the user may select contacts from the user device 10 address book, or alternatively, the user may select contacts from a remote address book, such as, for example Microsoft Outlook, Gmail or Skype, stored on a secondary user device 16. In one embodiment, the user may select individual devices associated with contacts from the user device address book, remote address book, or other database. In step 140, the contacts selected using the user device 10 or secondary user device 16 are added to the Local account associated with the user device 10, and the contacts may also be added to the Local client on the user device.

In step 150 and as shown in FIGS. 1 and 6B, the Local Server 12 may provide a local access number or other local access information for each contact or device selected by the user in step 130 so that the user device 10 may call the long distance and even international contacts as local calls using the local access numbers or other local access information provided by the Local Server. In one embodiment, the local access number or other local access information provided to the user device 10 by the Local Server 12 may be a local number for the user, as opposed to a long distance or international number or other local access information associated with the user's contacts. In one embodiment, he local access numbers for each contact may be stored in the Local client on the user device 10. Alternatively, the local access information may be stored in the address book of the user device 10 or the user's remote address book stored on the secondary user device 16, as the Local number for the contact.

If the user desires to use Local client to make international calls from different international locations (say, for example the user resides in the United Kingdom and frequently travels between the United Kingdom and Spain and wants to place calls and receive calls from his contacts when he is located in either country), the user device 10 may be setup using two SIMs or UIDs for the Local client, and may thus receive two local access numbers for each contact, a Spanish local access number and a United Kingdom local access number, each to be called from their respective SIMs. The user device 10 may be registered with the “Spain” SIM with the Local server 12 the first time the user device is used in Spain and all calls from contacts will be routed to the user device 10 with the Spain SIM, until the user device 10 returns to the United Kingdom and is again registered with the UK SIM with the Local server 12.

In step 160, the Local Server 12 may assign local access information, which may include local access numbers, to each contact device 14, even international contacts, which were selected by the user. As shown in FIG. 6B, the local access number assigned to the contact devices 14 (e.g. Ana's device) selected by the user may be a phone number that is a local number for the contact device, i.e., the contact may not incur any international access charges while dialing the local access numbers provided by the Local Server 12. The contact device 14 may be informed of the local access information that has been assigned to it by a robocall, text, e-mail, or voicemail from the Local Server 12. The message from the Local Server 12 may inform the contact that a local access information has been assigned for calling the user, and the contact device 14 may be used to call the user device 10 by dialing a local access number, irrespective of where the user device 10 may be located. The message may further inform the contact device 14 that if an incoming call from the user device 10 local access number arrives, then the contact device may be used to reject the incoming call and used to call the user device back at the local access number to avoid incurring international access fees for the call. The contact device 14 may save the local access information of the user device 10 in the address book of the contact device or to a remote address book, through automatic or manual procedures.

As shown in FIG. 6B, the Local Server may identify each contact that the user wants to call by a combination of the user device UID and the local access information that the Local Server 12 has assigned for the particular contact device 14. Likewise, as shown in FIG. 6B, the Local Server 12 may identify each user device 10 that the contact device 14 is used to call by a combination of the contact device phone number or the contact device UID and the local access information that was previously assigned to the contact device for contacting the user device. The Local Server can reuse one local access number or form of local access information for multiple user devices because the local access information does not, by itself, identify the destination to terminate the call. Instead, a calling destination, or where the call may be terminated, may be identified by the unique combination of the local access information and the UID of the user device 10 and/or the contact device 14. Thus, local access information need not be permanently associated with a UID, but only temporarily associated as needed.

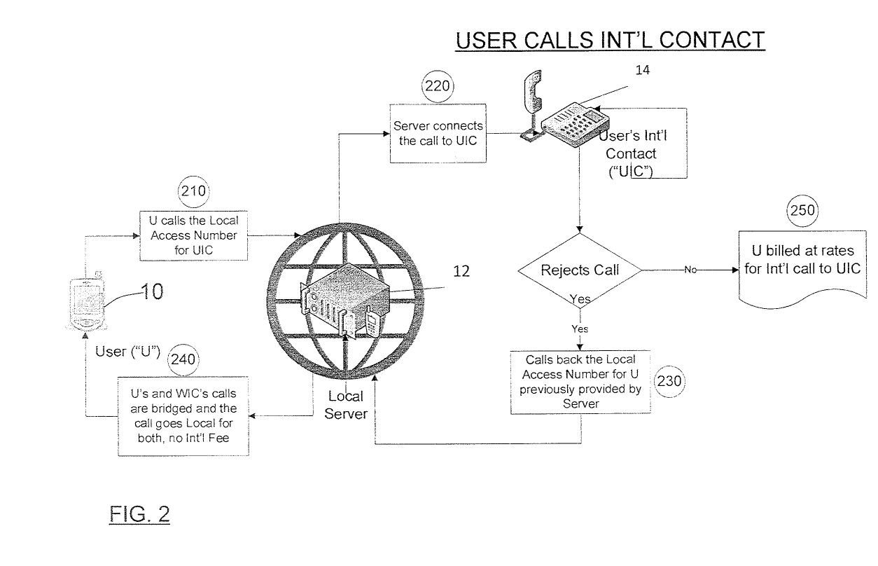

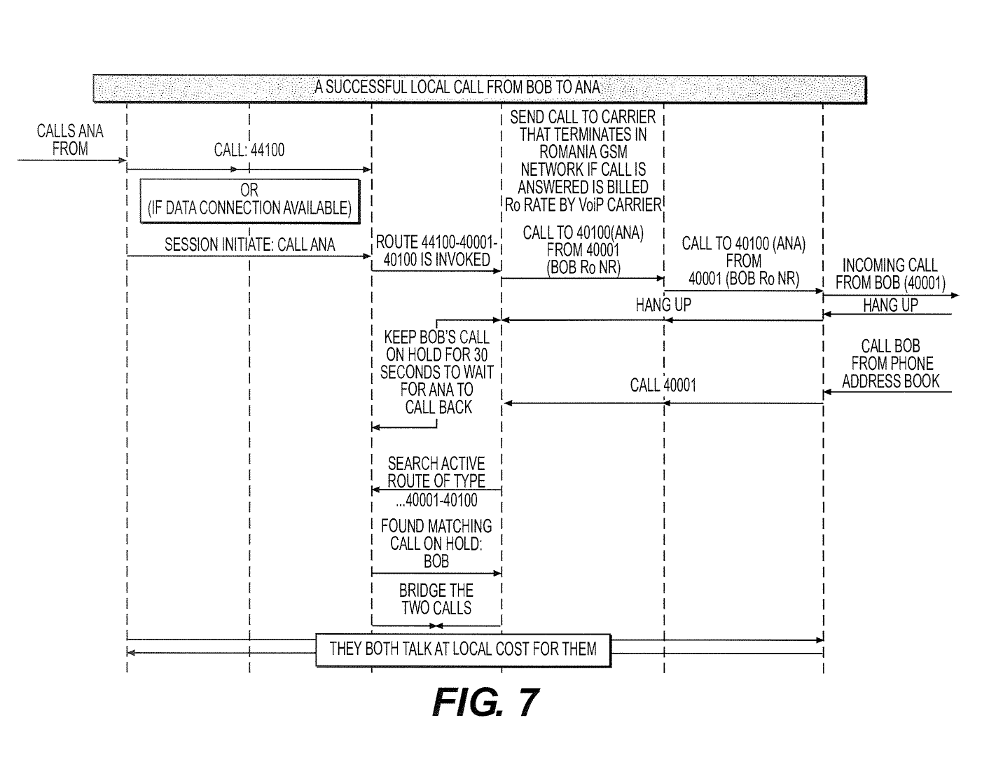

With reference to FIGS. 2, 7-8, a process of placing an international call using the Local service is illustrated according to one embodiment of the present teaching. As shown in FIG. 7, if a data connection is available, the user device 10 may initiate the call using the Local client. Else, the user device 10 may use the dialer to dial the local access number for the international contact device 14. As shown in FIG. 7 and in step 210 of FIG. 2, the user device 10 may call the local access number of the international contact device 14, and the Local Server 12 may identify the international contact device 14 that is being called by looking up its routing tables to identify the termination location for the combination of the UID and the local access number that was called by the user device 10. As shown in step 220 of FIG. 2, the Local Server 12 may then connect the call to the international contact device 14. As shown in FIG. 7, the international contact may receive notification of an incoming call from the user device 10 and the notification may show the user device caller ID as the user device local access number for the contact device 14 (i.e., a number that is a local number for the international contact device), which was previously provided to the international contact device.

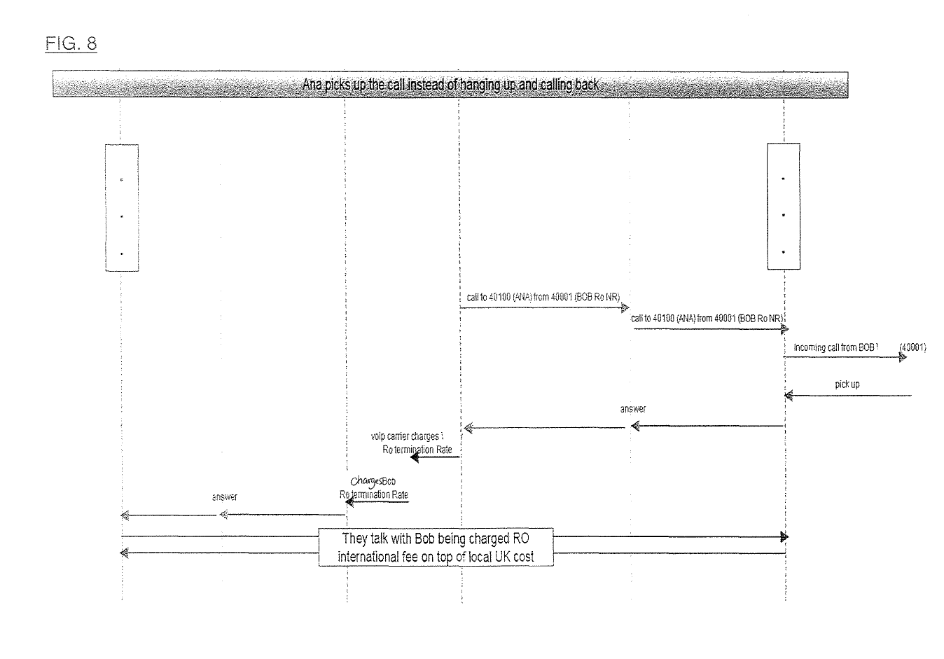

As shown in FIG. 8 and step 250 of FIG. 2, according to one embodiment of the present teaching if the international contact picks up the call from the user device 10, then the call proceeds as an international VoIP call and the user device 10 may be billed for the local call and the international access fees for terminating the call. On the other hand, as shown in FIG. 7 and step 230 of FIG. 2, if the international contact device 14 is used to reject or hang up the incoming call, the user device 10 call may be kept on hold by the Local Server 12, for example, for about 30 seconds, to enable the international contact device 14 to call back. As shown in FIG. 7 and step 230 of FIG. 2, if the international contact device is used to call its local access number for the user device 10 (the same number from whom the call was received), the Local Server 12 looks up the information required to associate the two calls in its routing table and bridges the two associated calls. As shown in FIG. 7 and step 240 of FIG. 2, the call now proceeds as local call to both the user device 10 and the international contact device 14, and international access fees are avoided for the call. Both the user device 10 and the international contact device are charged only the local calls that they made and any additional tariff levied by the Local service provider. If the call was initiated by the user device 10 from a data connection, then the user device 10 may avoid even the charges for the local call and may only be charged for the data connection and the Local service tariff, if any.

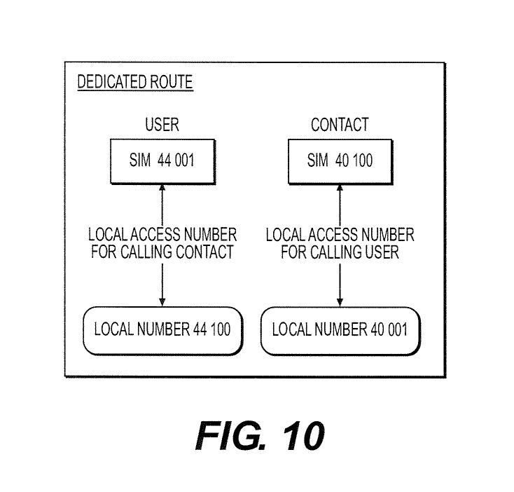

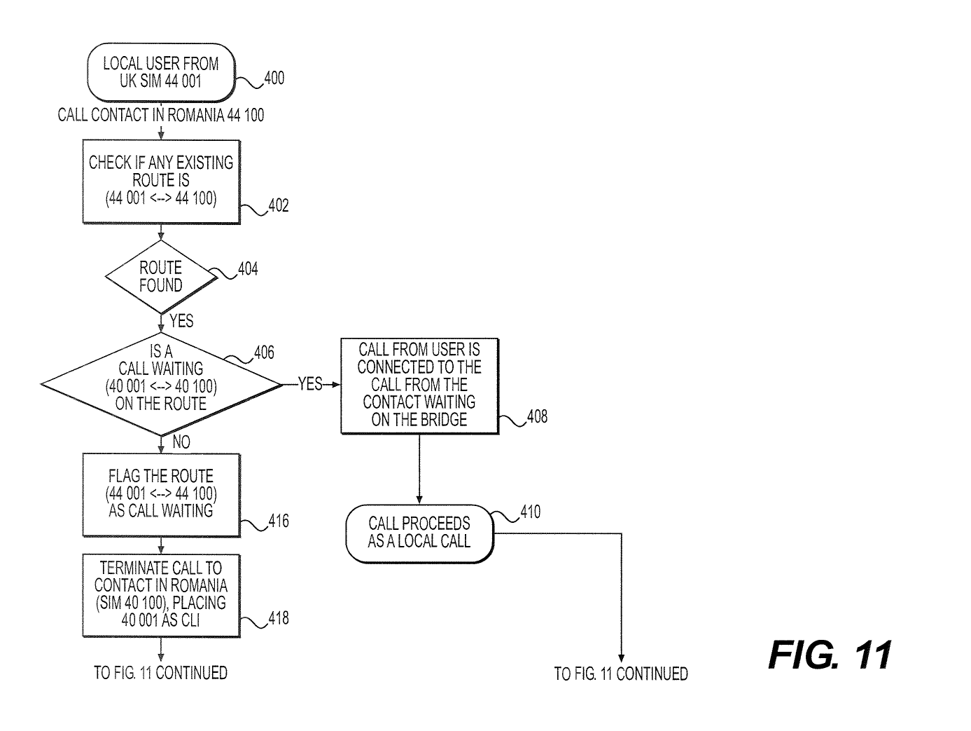

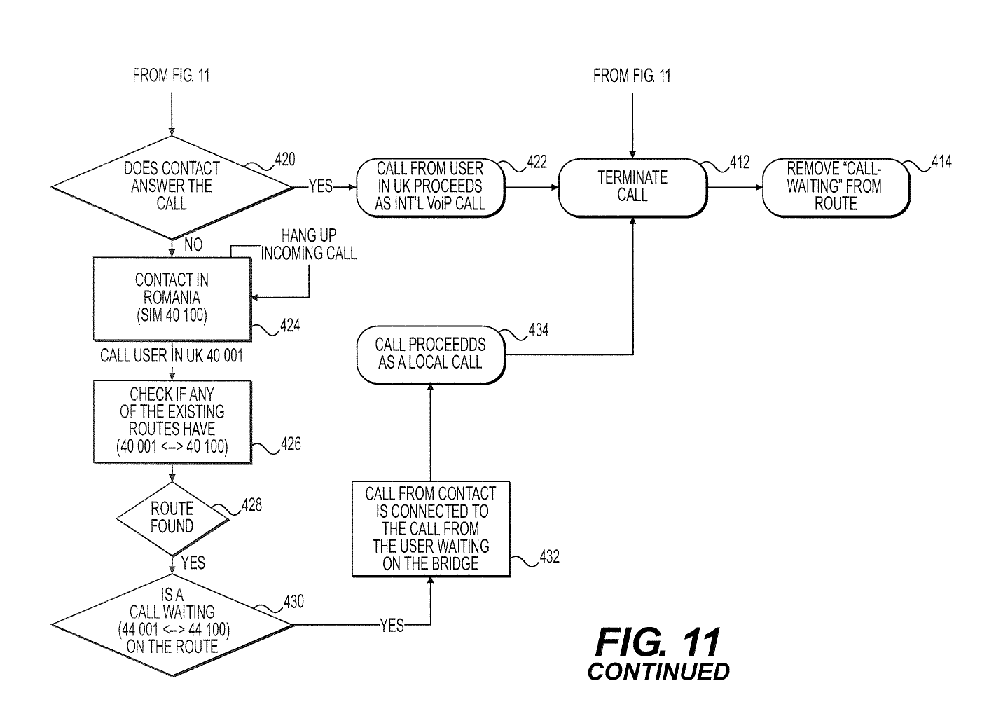

The routing of a call between the user device 10 and the contact device 14 according to one embodiment of the present teaching is further illustrated in FIGS. 10 and 11, and explained with reference to a user device 10 located in the United Kingdom and a contact device 14 located in Romania. As explained above and shown in FIG. 10, after the user device 10 may register for Local service, the SIM of the user device 10 (44 001) may be assigned a local access number (44 100) for calling a contact device 14 in Romania. Likewise, the SIM of the contact device 14 (40 100) in Romania may be assigned a local access number (40 001) for calling the user device 10 in the United Kingdom. As shown in FIG. 10, a two-way route may be built between the user device 10 in the United Kingdom (SIM 44 001) and the contact device 14 in Romania (SIM 40 100) and the two Local Numbers 44 100 and 40 001. The route may be designated as [44 001<->44 100]<->[40 001<->40100], i.e., whenever 44 001 calls 44 100 the system is configured to terminate the call to 40 100 placing 40 001 as the caller line identifier (“CLI”) and whenever 40 100 calls 40 001 the system is configured to terminate the call to 44 001 with 44 100 as the CLI.

A Local call between the user device located in the United Kingdom and the contact device 14 located in Romania may be completed according to one embodiment of the present teaching as shown in FIG. 11 and as described below. As shown in FIG. 11, when the user device 10 in the United Kingdom (SIM 44 001) calls 44 100 to reach the contact device 14 in Romania (SIM 40 100), the Local Server 12 may perform the following steps to complete the call. The Local Server 12 may check to determine if any of the existing routes is configured for 44 001<->44 100. If the 44 001<->44 100 route is found (steps 400, 402 and 404), the Local Server 12 may check to determine if there is a call waiting (40 001<->40 100) on the route, i.e., to determine if the contact device 14 in Romania (SIM 40 100) initiated the call and the user device 10 in the United Kingdom (SIM 44 001) is calling back to establish a Local call (step 406), or whether the user device 10 in the United Kingdom (SIM 44 001) initiated the call. If there is a call waiting on the route, then the call from the user device 10 in the United Kingdom (SIM 44 001) is connected to the contact device 14 in Romania (SIM 40 100) waiting on that bridge and the international call [44 001<->44 100]<->[40 001<->40 100] proceeds as Local call (steps 408 and 410) until terminated (step 412). If the route (40 001<->40 100) is not flagged as call waiting, then the (44 001<->44 100) route is flagged as call waiting (step 416) by the Local Server 12. The call from the user device 10 in the United Kingdom (SIM 44 001) is terminated to the contact device 14 located in Romania (SIM 40 100) placing 40 001 as the CLI (step 418). If the contact device 14 located in Romania (SIM 40 100) answers the call, the call goes through as an international VoIP call and the user device 10 in the United Kingdom (SIM 44 001) may be charged for the local call and the international access fees for terminating the call in Romania until hang up (steps 420, 422 and 412). If the contact device 14 located in Romania (SIM 40 100) rejects or hangs up (step 424) and calls the user device 10 in the United Kingdom (SIM 44 001), the two matching calls are bridged and the international call [44 001<->44 100]<->[40 001<->40 100] proceeds as a Local call (steps 426, 428, 430, 432 and 434) until the call is terminated (step 412) when the route is un-flagged from being on a “call-waiting” status by the Local Server 12.

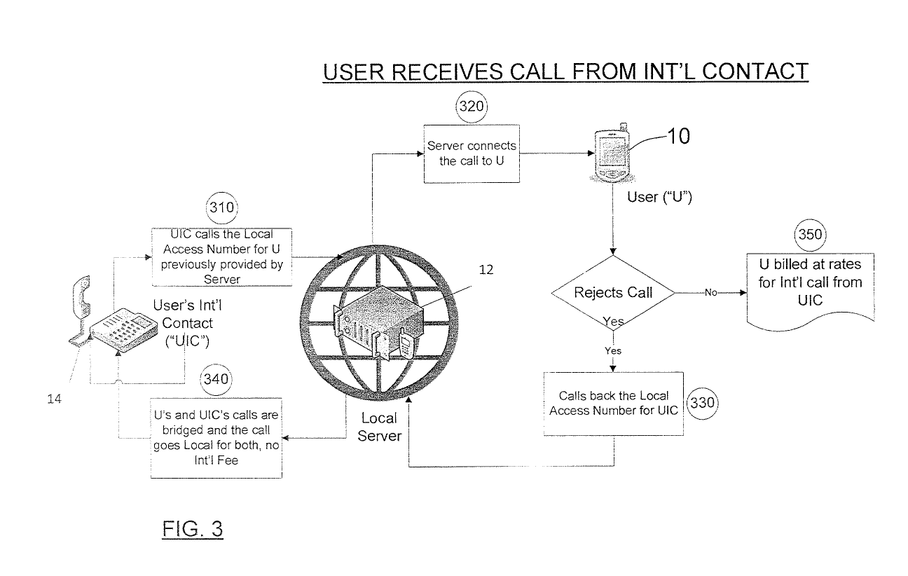

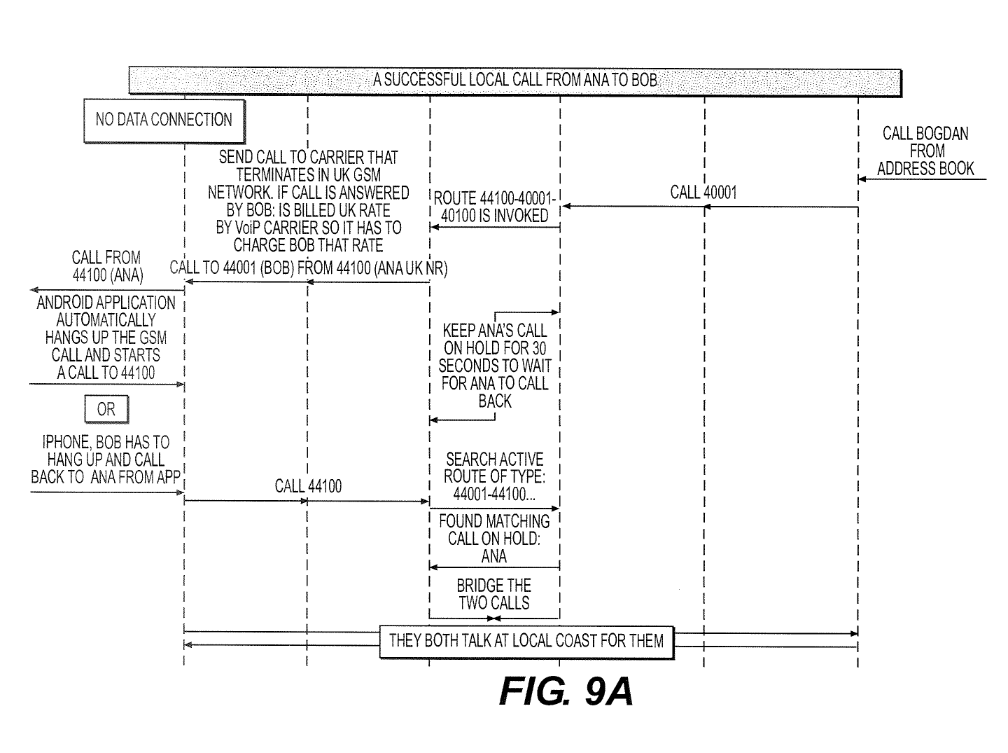

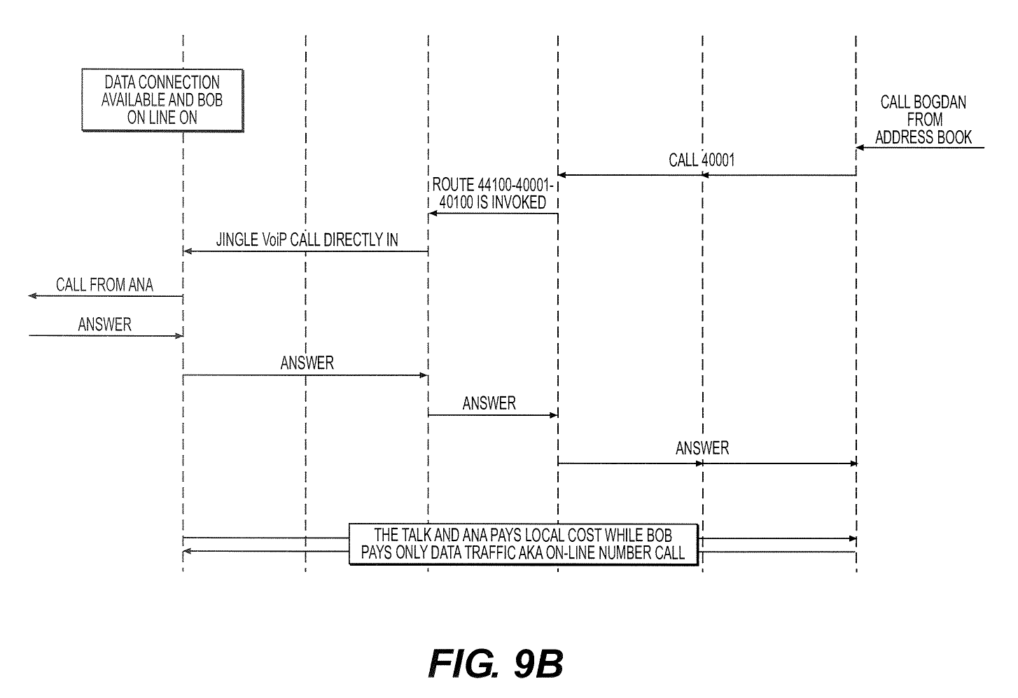

With reference to FIGS. 3 and 9A and 9B, the process of receiving an international call using the Local service is illustrated. As shown in FIGS. 9A and 9B and step 310 of FIG. 3, the international contact device 14 may initiate the call by dialing the user device 10 local access number that was provided to the international contact device by the Local Server 12. The Local Server 12 may notify the user device 10 that the international contact device 14 is attempting to call by identifying the combination of the international contact device phone number or UID and the local access number that was dialed. As shown in FIG. 9A and step 320 of FIG. 3, the Local Server 12 may attempt to connect the call to the user device 10 using the local access number (i.e., a number that is a local number for the user device 10) for the international contact device 14 that it had previously provided to the user 10.

According to one embodiment of the present teaching as shown in FIG. 9B, if a data connection is available and the user device 10 is logged onto the Local client, the user device 10 receives a notification that the international contact device 14 is calling. If the call from with the Local client is answered, the call proceeds as local call for the international contact device 14 and as data traffic for the user device 10. As a result, the international contact device 14 may only be charged the charges for the local call and the user device 10 only incurs the cost for the data connection and avoids even the charges for the local call.

As shown in step 350 of FIG. 3, if the user device 10 is not logged onto the Local client and the user device is used to answer the international contact device 14 call, then the call proceeds as an international VoIP call and the user device 10 is billed for the local call and the international access fees for terminating the call. On the other hand, as shown in FIG. 9A and step 330 of FIG. 3, if the user device 10 rejects or hangs up the incoming call, the international contact device 14 call may be kept on hold by the Local Server 12, for example, for about 30 seconds, to enable the user device 10 to call back. As shown in FIG. 9A and step 330 of FIG. 3, if the user device 10 is used to call back the local access number for the international contact device (the same number from which the call was received), the Local Server looks up its routing table and bridges the two matching calls. As shown in FIG. 9A and step 340 of FIG. 3, the call now proceeds as a local call to both the user device 10 and the international contact device 14 and international access fees are avoided for the call. Both the user device 10 and the international contact device 14 are charged only the charges for the local calls that they made and any additional tariff levied by the Local service. It is appreciated in all embodiments of the invention, that when the user device 10 and/or international contact device 14 is used to reject or hang up on an incoming call, the call back to the local access number required to complete the call without incurring international calling charges, may be made automatically as a result of operation of the Local client or other software provided on the devices.

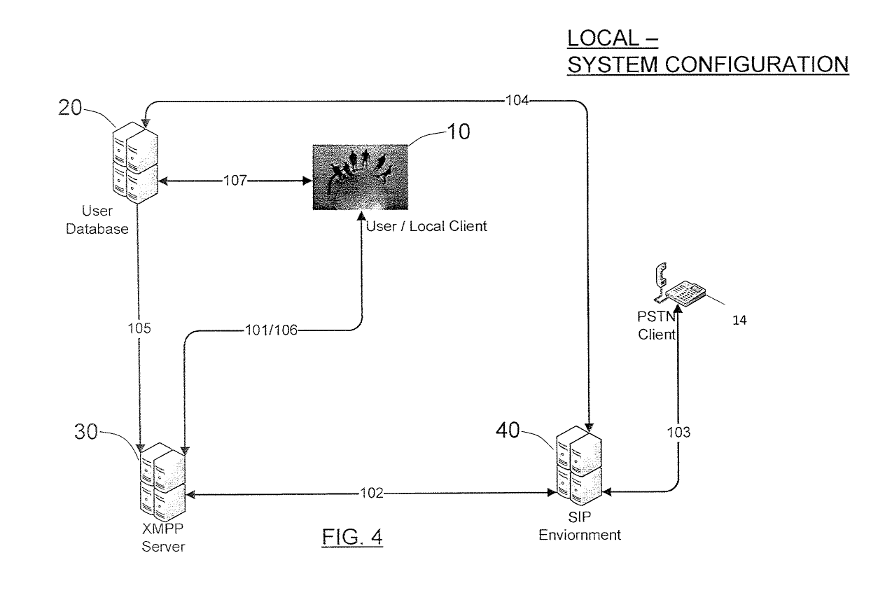

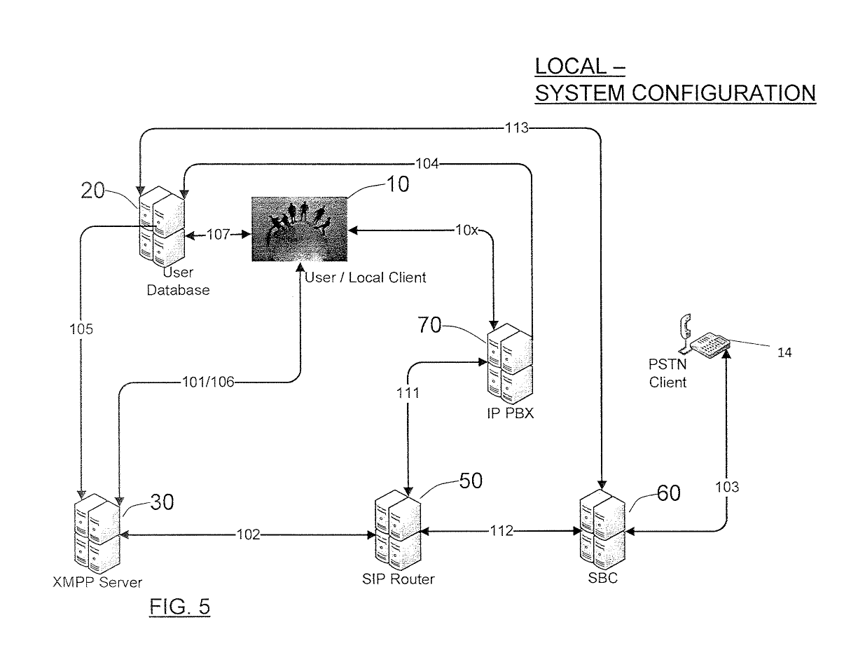

With reference to FIGS. 4-5, an embodiment of the system architecture for the Local server and associated devices is shown. As shown in FIG. 4, one embodiment of the system may include a Local Client 10, a User Database 20, a XMPP Server 30, and a SIP Environment 40 connected via a network. The network may preferably be or include the Internet, but also may be or include any wired or wireless connection means that permit the transmission of data and/or electronic information.

The User Database 20 may have a dedicated database assigned to it and may comprise one or more computers (including processing and memory devices) that collectively provide through hardware and/or software implementation the User Database 20. As shown in FIG. 4, the User Database 20 may be connected via wired or wireless connection to one or more computers (including processing and memory devices) that collectively provide through hardware and/or software implementation the XMPP Server 30. As shown in FIG. 4, the User Database 20 may further be connected via wired or wireless connection to one or more computers (including processing and memory devices) that collectively provide through hardware and/or software implementation, the SIP Environment 40.

The XMPP Server 30, for example an Ejabberd server, may be an Extensible Messaging and Presence Protocol (XMPP) application server, which also serves as the messaging server. The XMPP Server 30 may also serve as an authentication gateway. The XMPP Server 30 may provide user management services as well. For example, all the active and inactive users of the Local service may be verified at the XMPP Server 30.

As shown in FIG. 5, the XMPP Server 30 may be connected via wired or wireless connection to one or more computers (including processing and memory devices) that collectively provide through hardware and/or software implementation the SIP Environment 40. As shown in FIG. 4, the XMPP Server 30 and the User Database 20 may be connected via wired or wireless connection to the Local client 10.

The SIP Environment 40 may provide Session Initiation Protocol (“SIP”) proxy/router services that may also include application-level functionalities. The SIP Environment 40 may include modules which provide applications by default including conferencing, XML-RPC control of live calls, Interactive voice response (IVR), TTS/ASR (text to speech/automatic speech recognition), Public switched telephone network (PSTN) interconnection ability supporting both analogue and digital circuits, VoIP protocols including SIP, SCCP, H.323, XMPP, GoogleTalk, t.38 and others. In the present embodiment, the SIP Environment 40 may also serve as the transporting cluster and may handle the transportation or the media of the call. For example, the SIP Environment 40 may ensure that both the incoming codec that is being sent and the codec that is requested from the other end are the same. The SIP Environment 40 may also provide carrier routing and management solution. For example, SIP Environment 40 may provide the billing platform and also serves as the PSTN Gateway, i.e., the barrier between the internet and the PSTN network.

With reference to FIG. 4, operation of an embodiment of the present invention for completing a call on the Local platform will now be described. The Local client may initiate a call through the Jingle Protocol. Jingle is an extension to the Extensible Messaging and Presence Protocol (XMPP) that adds peer-to-peer (P2P) session control (signaling) for multimedia interactions such as in VoIP or videoconferencing communications. As shown in step 101, the Local client initiates a call using Jingle Protocol to the XMPP Server 30.

To complete a call from a Local client to a contact device 14, the call may be converted from Jingle protocol to SIP protocol. The XMPP Server 30 may have a custom module that may convert the Jingle protocol to SIP protocol and, as shown in step 102, the call may then be relayed on to the SIP Environment 40. The Local server may use a codec called ILBC, which is a narrowband codec, and works at about 8 Kilobits per second, while PSTN clients rely upon a codec called G711. The SIP Environment 40 may transcode the call, i.e., convert the call from ILBC to G711 or whatever codec may be requested. Thereafter, as shown in step 103, the call may be relayed from the SIP Environment 40 to the contact device 14.

As shown in step 104, at the end of the call, the SIP Environment 40 may send an end-call notification to User Database 20. As shown in step 104, on receiving the end-call notification, the User Database 20 may query the SIP Environment 40 for user device 10 remaining credit balances. As shown in step 105, the User Database 20 may push the balance update to the XMPP Server 30. As shown in step 106, the XMPP Server 30 may push a notification of balance update to the Local client 10. As shown in step 107, the Local client 10 may query the User Database 20 which may return the updated balance and the available credit for the Local client 10.

In an alternate embodiment of the present invention, shown in FIG. 5, the SIP Environment 40 is broken up into three components, SIP Router 50, Internet protocol private branch exchange (IP PBX) 70, and Session Border Controller (“SBC”) 60. The SIP Router 50, for example OpenSIPS Server, may be Session Initiation Protocol (“SIP”) proxy/router that also includes application-level functionalities. The SIP Router 50 may provide a customizable routing engine that unifies voice, video, IM and presence services in a scalable (modular) design and may handle the signaling part of the call. As shown in FIG. 5, the SIP Router 50 may be connected via wired or wireless connection to the XMPP Server 30, IP PBX 70, and the SBC 60.

The IP PBX 70, for example, FreeSwitch server, may include many modules which provide applications by default including conferencing, XML-RPC control of live calls, Interactive voice response (IVR), TTS/ASR (text to speech/automatic speech recognition), Public switched telephone network (PSTN) interconnection ability supporting both analogue and digital circuits, VoIP protocols including SIP, SCCP, H.323, XMPP, GoogleTalk, t.38 and others. The IP PBX 70 may permit call control applications to use the Event Socket and it may also provide an Event Socket Library (ESL) and “ESL-wrappers” for a variety of programming languages. In the present embodiment, the IP PBX 70 may serve as the transporting cluster and may handle the transportation, or the media of the call. For example, the IP PBX 70 may ensure that both the incoming codec that is being sent and the codec that is requested from the other end are the same. As shown in FIG. 5, the IP PBX 70 may be connected via wired or wireless connection to the SIP Router 50 and the User Database 20.

The SBC 60, for example a Digitalk server, may provide carrier routing and management solution. In the present embodiment, SBC 60 may provide the billing platform and also serves as the PSTN Gateway, i.e., the barrier between the Internet and the PSTN network. As shown in FIG. 5, the SBC 60 may be connected via wired or wireless connection to the SIP Router 50 and the User Database 20.

As explained above, the call may be initiated by the user device 10 and after converting the Jingle protocol to SIP protocol, the XMPP Server 30 may relay the call to the SIP Router 50. As shown in FIG. 5, in step 111, if transcoding is required, the call is pushed to IP PBX 70 for transcoding. As shown in FIG. 5, the call is transcoded and pushed back to the SIP Router 50, and as shown in step 112, the call proceeds to the SBC 60. As shown in step 104, the call is relayed from the SBC 60 to the contact device 14.

As shown in step 104, at the end of the call, IP PBX 70 may send an end-call notification to the User Database 20. As shown in step 113, on receiving the end-call notification, the User Database 20 may query SBC 60 for user's 10 remaining credit balances. As shown in step 105, the User Database 20 may push the balance update to the XMPP Server 30. As shown in step 106, the XMPP Server 30 may push a notification of balance update to the Local client on the user device 10. The Local client 10 may query the User Database 20 and the User Database 20 may return the updated balance and the available credit for the Local client 10.

The present invention also relates to an apparatus for performing the operations herein. The algorithms and displays presented herein are not inherently related to any particular computer, network of computers, or other apparatus. Various general-purpose systems may be used with programs in accordance with the teachings herein, or it may prove convenient to construct more specialized apparatus to perform the required method steps. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus. The required structure for a variety of these systems appears from the description. In addition, the present invention is not described with reference to any particular programming language. It will be appreciated that a variety of programming languages may be used to implement the teachings of the invention as described herein.

As will be understood by those skilled in the art, the invention may be embodied in other specific forms without departing from the spirit or essential characteristics thereof. For example, the particular architecture depicted above are merely exemplary of one implementation of the present invention. The functional elements and method steps described above are provided as illustrative examples of one technique for implementing the invention; one skilled in the art will recognize that many other implementations are possible without departing from the present invention as recited in the claims. In addition, the present invention may be implemented as a method, process, user interface, computer program product, system, apparatus, or any combination thereof. Accordingly, the disclosure of the present invention is intended to be illustrative, but not limiting, of the scope of the invention. It is intended that the present invention cover all such modifications and variations of the invention, provided they come within the scope of the appended claims and their equivalents.

What is claimed is:

1. A telecommunication method comprising:
retrieving, using a telecommunications system, an electronically stored first identifier associated with a first device;
retrieving, using the telecommunications system, an electronically stored second identifier associated with a second device;
temporarily assigning, using the telecommunications system, first local access information to the first device;
associating, using the telecommunications system, the first local access information with the first identifier;
temporarily assigning, using the telecommunications system, second local access information to the second device;
associating, using the telecommunications system, the second local access information with the second identifier; and
establishing a bridged communication, under the control of the telecommunications system, between the first device and the second device using the first local access information and the second local access information.

2. The method of claim 1, wherein the first identifier and second identifier each comprise one or more of a phone number, SIM card number, ESN, IMEI number, IMSI number, proxy ID, personal user ID, mobile device user ID, application user ID, MAC address, and biometric information.

3. The method of claim 1, wherein the first identifier is selected from one or more items maintained in a database accessible from the first device.

4. The method of claim 1, wherein the local access information is a local access telephone number.

5. The method of claim 1, wherein the local access information comprises multiple local access telephone numbers, each associated with a different network.

6. The method of claim 1 further comprising wherein communication between the first device and the second device comprises a VoIP communications.

7. The method of claim 1, wherein the communication between the first device and the second device comprises a local call with each device bridged by the telecommunications system.

8. The method of claim 1, wherein the communication between the first device and the second device comprises providing, using the telecommunications system, the second device with the access information that can be used to initiate a communication with the first device.

9. The method of claim 1, wherein the communication is established after a call initiated by the first device to the second device has been placed on hold, using the telecommunications system, and the telecommunications system has received a call from the second device directed to the first device using the local access information associated with the first device.

10. The method of claim 1, wherein the communication is established after a call initiated by the first device to the second device has been rejected by the second device, using the telecommunications system, and the telecommunications system has received a call from the second device to the first device using the local access information associated with the first device.

11. A telecommunication method comprising:
retrieving, using a telecommunications system, an electronically stored first identifier associated with a first device;
retrieving, using the telecommunications system, an electronically stored second identifier associated with a second device;
temporarily assigning, using the telecommunications system, second local access information to the second device;
associating, using the telecommunications system, the second local access information with the second identifier; and
placing a call, under the control of the telecommunications system, from the first device to the second device using the second local access information.

12. The method of claim 11, further comprising establishing a communication between the first device and the second device.

13. The method of claim 12, wherein communication between the first device and the second device proceeds as a VoIP call.

14. The method of claim 12, wherein the communication between the first device and the second device comprises a local call with each device bridged by the telecommunications system.

15. The method of claim 12, wherein the communication between the first device and the second device comprises providing, using the telecommunications system, the second device with the first local access information that can be used to initiate a communication with the first device.

16. The method of claim 11, further comprising:
placing the call from the first device to the second device on hold, using the telecommunications system;
temporarily assigning, using the telecommunications system, first local access information to the first device;
associating, using the telecommunications system, the first local access information with the first identifier;
establishing a communication between the first device and the second device using the first local access information and second local access information.

17. The method of claim 11, further comprising:
rejecting the call from the first device to the second device, using the telecommunications system;
temporarily assigning, using the telecommunications system, first local access information to the first device;
associating, using the telecommunications system, the first local access information with the first identifier;
providing the first local access information to the second device;
establishing a communication between the first device and the second device using the first local access information and second local access information.

18. A telecommunication method comprising:
activating, using a telecommunications system, a first communication device on a local server;
authenticating the first communication device, using a telecommunications system;
retrieving an electronically stored first identifier associated with the communication device, using a telecommunications system;
establishing, using a telecommunications system, an account for the first communication device;
adding one or more selected contacts accessible from the first communication device to a database associated with the account for the first communication device, using a telecommunications system;
retrieving, using the telecommunications system, an electronically stored second identifier associated with a second communication device associated with one of the selected contacts;
temporarily assigning, using the telecommunications system, local access information to the second communication device;
associating, using the telecommunications system, the second local access information with the second identifier;
providing the local access information assigned to the second communication device to the first communication device.

19. The method of claim 18, wherein the first identifier and second identifier each comprise one or more of a phone number, SIM card number, ESN, IMEI number, IMSI number, proxy ID, personal user ID, mobile device user ID, application user ID, MAC address, and biometric information.

20. The method of claim 18, wherein the local access information is a local access telephone number.

21. The method of claim 18, wherein the local access information comprises multiple local access telephone numbers, each associated with a different network.

22. The method of claim 18, wherein the communication between the first communication device and the remote communication device comprises a VoIP communications.

23. Wherein the communication between the first communication device and the remote communication device comprises a local call to each device.

24. The method of claim 1, wherein the communication between the first communication device and the remote communication device comprises providing, using the telecommunications system, the second device with the access information that can be used to initiate a communication with the first device.

25. The method of claim 1, wherein the communication between the first communication device and the remote communication device is established after a call initiated by the first device to the second device has been placed on hold, using the telecommunications system, and the telecommunications system has received a call from the second device directed to the first device using the local access information associated with the first device.

26. The method of claim 1, wherein the communication between the first communication device and the remote communication device is established after a call initiated by the first device to the second device has been rejected by the second device, using the telecommunications system, and the telecommunications system has received a call from the second device to the first device using the local access information associated with the first device.

27. A communications system comprising:
a first communication device capable of accessing a local client application;
a database suited to electronically maintain information about one or more communication devices, the information comprising an identifier associated with a communication device and local access information for the communication device;
an XMPP server adapted to communicate with the local client application;
a SIP Environment connected to the XMPP server and adapted to communicate with at least one of the one or more communication devices; and
a user database accessible to the XMPP server and the SIP Environment.

28. The communications system of claim 27, wherein the XMPP server further comprises an authentication gateway.

29. The communications system of claim 27, wherein the XMPP server is capable of providing user management services.

30. The communications system of claim 27, wherein the SIP Environment further comprises an SIP router, an IP PBX, and an SBC.
